(19) United States
(12) Patent Application Publication
(10) Pub. No.: US 2002/0109820 A1
(43) Pub. Date: Aug. 15, 2002

(54) Color management system of liquid crystal-display projecting apparatus

(76) Inventor: Jui-Wen Pan, Taoyan County (TW)

Correspondence Address: BIRCH STEWART KOLASCH & BIRCH, PO BOX 747, FALLS CHURCH, VA, 22040-0747, US

(21) Appl. No.: 09/817,377

(22) Filed: Mar. 27, 2001

(30) Foreign Application Priority Data
Feb. 13, 2001 (TW) 90202190

(51) Int. Cl. G03B 21/14; G02F 1/1335

(52) U.S. Cl. 353/20; 353/31; 349/9

(57) ABSTRACT

A beam-split system of an LCD projecting apparatus for improving the contrast effect receives light from the light source of the LCD projecting apparatus and signal of an image to be projected, and outputs images to be projected. The beam-split system includes a plurality of polarizing filters, a plurality of polarization beam splitters (PBS), and three sets of LCD panels. The polarizing filters are for transferring a polarization state of a specific color beam. The PBSs are disposed in the light-path where the polarizing filter located, and each of PBSs includes a pair of prisms for splitting the color polarizing light beam that is incident through the PBS. The LCD panels are to reflect respectively the above-mentioned polarizing light beams having three different colors, and in the meantime, change their polarization state. The characteristics of the beam-split system is as follows: at least a peripheral wall, among those peripheral walls of each of the prisms of the PBS not being passed by the light path, is a polished surface. This is to make most of the stray light beam, that is incident upon the polished surface in the beam-split system, transmit through the polished surface. Therefore, it can greatly reduce the stray light beam in the beam-split system, and diminish the signal noise of the output light, and enhance the contrast effect of the output images.

### FIELD OF THE INVENTION

The invention relates to an improvement for a beam-split system of a liquid crystal display (LCD) projecting apparatus, and in particular, relates to a beam-split system having a specific polishing treatment to diminish the stray light beam.

### BACKGROUND OF THE INVENTION

Reflective liquid crystal (LCD) display projector is a popular product whose major optical mechanism includes an optical beam-split system. As far as the beam-split system of the reflective LCD projector is concerned, it is composed of the optical devices such as a polarizing light beam splitter (PBS) and a reflective twisted nematic LCD panel etc., and in association with an off-axis or an on-axis light-path design. Among them, although the light-path design for the on-axis is advantageous in the design and manufacturing, it's hard to attain high contrast effect.

FIG. 1 is a cross-sectional view of light-path principle of the beam-split system according to a prior art. The beam-split system includes four sets of PBS and reflective LCD panels with red, blue and green three original colors, and employs the on-axis light-path design. As shown in FIG. 1, the beam-split system 10 includes four sets of PBS 11, 12, 13 & 14, four sets of polarizing filter 15, 16, 17 & 18, a green reflective LCD panel 20, a blue reflective LCD panel 21, a red reflective LCD panel 22, and a polarizer 19. Each of PBS includes two sets of prisms, that is, the PBS 11 includes prisms 111 & 112, the PBS 12 includes prisms 121 & 122, the PBS 13 includes prisms 131 & 132, and the PBS 14 includes prisms 141 & 142.

The light source 1 of the beam-split system 10 generates polarizing light beam 2 in S-polarization state which being reflected by the three LCD panels 20, 21 & 22 receives the signal of an image to be projected, therefore, the beam leaving the beam-split system projects an image, represented by the signal, to be projected.

Polarizing filters 15, 16, 17 & 18 being formed by phase retarders can filter a specific color of polarizing light beam. The polarizing filters 15 & 18 can make the red & blue beams passing through them keep in the same polarization state while make the green beam passing through them transform from S-state of polarization to P state. However, the polarizing filters 16 & 17 can make the blue beam passing through them keep in the same polarization state while make the red beam passing through them transform from S-state of polarization to P-state.

As shown in FIG. 1, while the polarization beam reaches the interface of the color-split lens 111 & 112, the red-blue beam (RIB beam) 2a being in s-state is reflected and transmitted toward the polarizing filter 16. And the green beam component 2b being in P-state transmits through prisms 112 and enters into the PBS 12.

The green beam component 2b, after transmitting through the interface of the prisms 121 & 122 and being reflected by the LCD panel 20, transforms from P-state into green-beam 3b in S-state. The green beam 3b, after continuing to transmit through the PBS 14 and being reflected by the interface of the prisms 141 & 142, then transmits through polarizing filter 18. In this way, the green beam 3b can transform from S-state to P-state, and finally pass through the polarizer 19, thereby, form green beam component 4b (G-beam component) of the projecting image.

In the same manner, the polarizing filter 16 can divide the R/B beam 2a into blue beam 21a in S-state and red beam 21b transforming from S-state to P-state. The red beam 21b, after transmitting through the interface of the prisms 131 & 132 and being reflected by the red LCD panel 22, transforms into red beam 2b in S-state. The red beam 2b, after continuing to transmit through the polarizing filter 17, transforms from S-state into P-state, after that, transmits through polarizer 19 and forms a red beam component 23b of projecting image.

In addition, blue-beam 21a, after being reflected respectively by the interface of the prisms 131 & 132 and the blue LCD panel 121, transfers into blue beam 22a in P-state entering into the PBS 14. Subsequently, it keeps on transmitting through the polarizing filter 17, the prisms 141 & 142, the polarizing filter 18 and the polarizer 19, finally becomes a blue beam 23a of projecting image.

Consequently, the three P-state beams of the red, blue and green beam components 23b, 23a & 4b are combined to become the projecting image of the LCD projector.

The above-mentioned beam-split system 10 of the prior art can't generate a projecting image with a perfect contrast effect.

Following are the reasons for why the contrast effect is reduced:

1. The interface of the two prisms of the PBS and the material itself can't reach the ideal condition, thereby, some of P-state polarizing light beams still reflects into the interface of the two prisms. For example, a few of the P-state green beam components 2b will still be reflected together with the S-state R/B beam component 2a.

2. Polarizing filter has a poor polarizing transfer efficiency to transfer the incident polarizing light beam component such that P-state green beam component 2b is mixed up with some of S-state green beam component together reflected by the interface of the prisms 121 & 122. In this way, P-state red beam 21b is also mixed up with S-state red beam component, and all of these will affect the contrast of the final projecting image.

3. Homotropic LCD panel is not easy to manufacture. In general, nematic LCD panel only has perfect polarization effect for the wavelength within a certain range of wavelength. If the incident color beam component transmitting through each of the LCD panels is mixed up with the other color beam components, it will affect the contrast of the final image.

4. Nematic LCD panel can't completely transfer the polarization state of the incident beam, thereby, the stray light will increase to fill in the beam-split system.

Consequently, the beam-split system 10 of the prior art is actually filled with stray-light beam components resulted from various reasons. Most of these beam components in various colors are reflected by each the peripheral walls and the interface between the prisms, and finally transmit through polarizer 19 to become a portion of a projecting image. Therefore, these stray-light beam components affect the contrast effect.

### SUMMARY OF THE INVENTION

An object of the invention is providing a beam-split system of an LCD projecting apparatus having a preferred contrast effect, it receives light from the light source of the LCD projecting apparatus and signal of an image to be projected, as well as outputs images to be projected. The beam-split system includes a plurality of polarization filters, a plurality of polarization beam splitters (PBS), and three sets of LCD panels. The polarizing filters are for transforming a polarization state of a specific color beam. The PBS is disposed on the light-path where the polarizing filter located, and each of PBS includes a pair of prisms for splitting the incident colorful polarizing light beam through the PBS. The LCD panels are to reflect respectively the above-mentioned polarizing light beams having three different colors and in the meantime, transform their polarization state. At least a peripheral wall, among those peripheral walls of each of the prisms of the PBS not being passed by the light path, is a polished surface. This is to make most of the stray light beam, that is incident upon the polished surface in the beam-split system, transmit through the polished surface. Therefore, it can greatly reduce the stray light beam in the beam-split system, and diminish the signal noise of the output light, and enhance the contrast effect of the output images.

### BRIEF DESCRIPTION OF THE DRAWING

FIG. 1 is a cross-sectional view of the light-path principle for a beam-split system according to a prior art.

FIG. 2 is a cross-sectional view showing the leaking-light source of the beam-split system in FIG. 1, and is employed to illustrate an improvement method for the beam-split system of the LCD projecting apparatus in accordance with the invention.

### DETAIL DESCRIPTION OF THE PREFERRED EMBODIMENTS

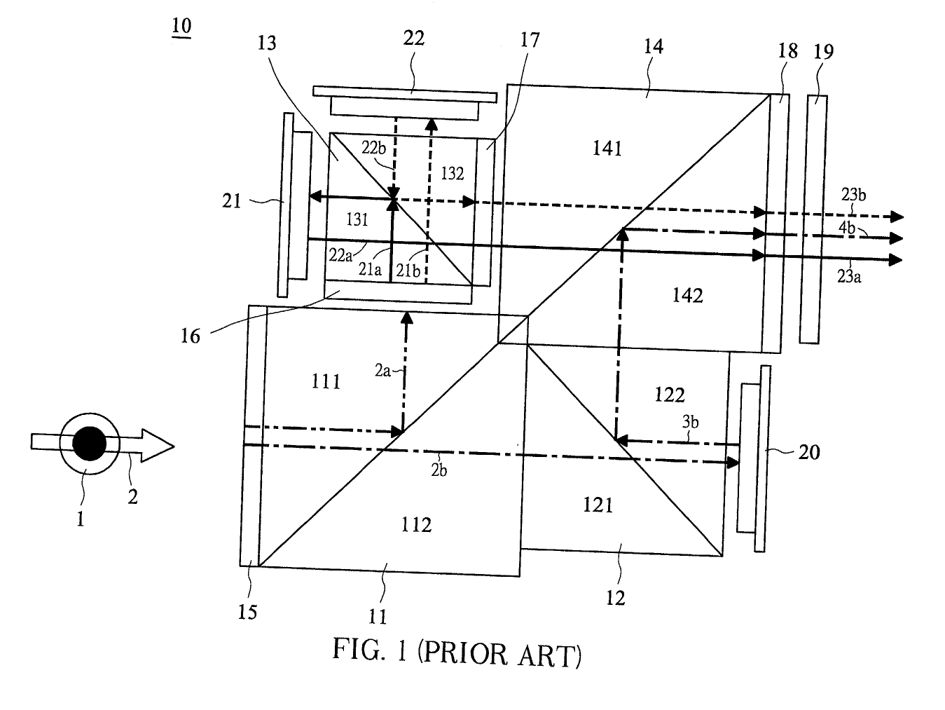

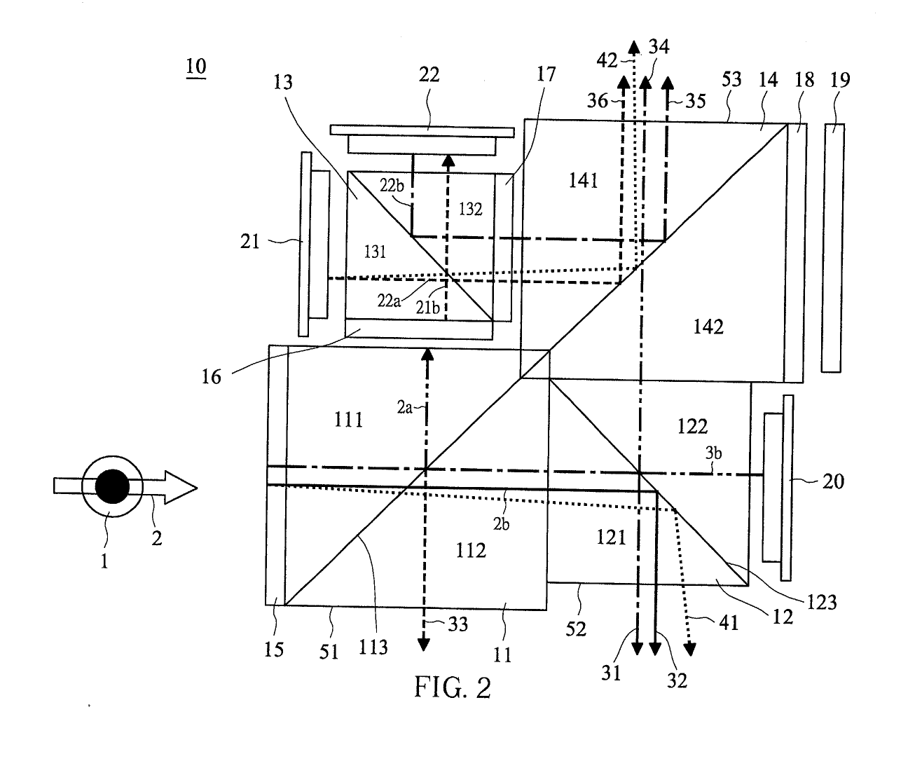

FIG. 2 is a cross-sectional view showing the leaking-light source of the beam-split system in FIG. 1, and is employed to illustrate an improvement method for the beam-split system of the LCD projecting apparatus in accordance with the invention.

The improvement for the beam-split system of the LCD projecting apparatus is mainly managed to diminish the stray light beam. One of the embodiments of the beam-split system 10 of the invention is shown in FIG. 1. The beam-split system includes four sets of PBS 11, 12, 13 & 14, four sets of polarizing filters 15, 16, 17 & 18, a green reflective LCD panel 20, a blue reflective LCD panel 21, a red reflective LCD panel 22 and a polarizer 19. Each of PBS respectively includes two sets of prisms, that is, the PBS 11 of prisms 111 & 112, the PBS 12 of prisms 121 & 122, the PBS 13 of prisms 131& 132, and the PBS 14 of prisms 141 & 142. The other light-path design and the system operating principle is the same as described in FIG. 1.

According to the embodiments of the invention shown in FIG. 2, the characteristic for improving the beam-split system is as follows: Those peripheral walls of each of the prisms not being passed by the light-path, such as peripheral walls of prisms 51, 52 & 53 are all the surfaces that are polished. Therefore, they can make most of the stray light beams transmit through the beam-split system 10.

As shown also in FIG. 2, in fact, the beam-split system 10 has several sources that generated stray light as described in the prior art. The reason for generating the stray light beam 31-36 is that the interface of the two prisms of PBS and the material itself can't reach the ideal condition, consequently, part of the polarization beam components is reflected and transmitted upon the interface. For example, the P-state green beam component 2b being reflected by the interface 123, generates stray light beam 31 transmitting through peripheral wall of prism 52 of the PBS 12. S state green beam 3b transmitting through interface 123 and being reflected by interface 113 generates stray light beam 33 transmitting through peripheral wall of prism 51 of PBS 11. Among them, the stray light beams 31 & 32 have the highest light intensity, the stray light beam 33 is next to the highest, while the stray light beam 34-36 is the weakest. Thereby, each of the peripheral walls of the PBS 12 being in charge of handling the green beam can receive relatively strong stray light comparing to the peripheral walls of the PBS 11 & 14. Since the peripheral walls of prisms 51, 52 & 53 are polished surfaces, the incident stray light beam has a much higher transmitting rate than reflecting rate. Thereby, the object of fully dispersing the stay lights out of the beam-split system 10 can be attained. Among them, the polished surfaces of the peripheral walls of the PBS 12 including peripheral wall of prism 52 have relatively significant effect to diminish the stay-light beam.

In addition to the stray-light beam 31˜36, the color-dispersing effect of the PBS material itself and the defect of the LCD's material will generate stray light beam 41 & 42 as shown in FIG. 2. Since the peripheral walls of prisms 51, 52 & 53 are polished surfaces, the stray light beam can easily transmit through the beam-split system.

The key point of the invention is to polish the peripheral wall of each of the prism not being passed by the light-path, in this way, the stray light can smoothly transmit out of the beam-split system after being reflected once or more. In this way, the stray light of the output beam of the beam-split system can be diminished, and the contrast effect of the output image is greatly enhanced.

Furthermore, the surfaces of the peripheral walls such as 51, 52, and 53 can be coated an anti-reflective film (not shown). In this way, the stray light transmitting through the peripheral walls 51, 52 and 53 will not re-enter to the beam-split system 10 due to the reflection of the members other than the beam-split system. Moreover, all the other stray light sources originated from any of the systems other than the beam-split system will not pass through the peripheral walls 51, 52 and 53, and transmit into the beam-split system.

While the invention has been described by way of example and in terms of a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. A beam-split system of a liquid crystal display (LCD) projecting apparatus receiving light beam from the light source of the LCD projecting apparatus and signal of an image to be projected, as well as outputing image to be projected comprising:
a plurality of polarizing filter, for transferring a polarization state of a specific color beam;
a plurality of polarizing light beam splitter (PBS) disposed on the light-path where the polarizing filter located, and each PBS includes a pair of prisms for splitting the incident color polarizing light beam through the PBS; and
three sets of LCD panels to reflect respectively the above-mentioned polarizing light beams having three different colors and in the meantime, transform their polarization state;
wherein at least a peripheral wall, among those peripheral walls of each of the prisms of the PBS not being passed by the light path, is a polished surface in order to make most of the stray light beam, that is incident upon the polished surface in the beam-split system, transmit through the polished surface.

2. The beam-split system of an LCD projecting apparatus of claim 1, wherein the polished surface of the peripheral wall is coated with a reflective film that reflects all the light beams, excluding those of the beam-split system, incident to the peripheral walls.

3. The beam-split system of an LCD projecting apparatus of claim 1, wherein the light beam incident from the light source of the beam-split system is an S-state polarizing light beam.

4. The beam-split system of an LCD projecting apparatus of claim 1, wherein the output light beam of the beam-split system is a P-state polarizing light beam.

5. The beam-split system of an LCD projecting apparatus of claim 1, wherein the beam-split system divides the incident light beam into three basic color light beams, and further makes the three basic color light beams incident to the three sets of LCD panels for forming images.

6. The beam-split system of a LCD projecting apparatus of claim 1, wherein each of the polarizing filters is a combination of phase retarder.

7. The beam-split system of a LCD projecting apparatus of claim 1, wherein the beam-split system is provided with four sets of polarizing filters, among them, two sets of them can transform one of the basic color's polarization state, another two sets can transform another one of the three basic colors' polarization state.

8. The beam-split system of an LCD projecting apparatus of claim 1, wherein the beam-split system further comprises four sets of polarization beam splitter.

9. The beam-split system of an LCD projecting apparatus of claim 1, wherein the LCD panel is a reflective twisted nematic LCD panel.

10. The beam-split system of an LCD projecting apparatus of claim 1, wherein a light beam polarizer is further provided at the end of the light path to enhance the contrast effect of the projected images generated by the beam-split system.
